(19) United States
(12) Patent Application Publication
(10) Pub. No.: US 2007/0278971 A1
(43) Pub. Date: Dec. 6, 2007

(54) System and method for open lamp protection

(75) Inventors: Yuancheng Ren, Hangzhou (CN); Peng Xu, San Jose, CA (US); Kaiwei Yao, Santa Clara, CA (US); Wei Chen, Campbell, CA (US)

Correspondence Address: PERKINS COIE LLP;PATENT-SEA, P.O. BOX 1247, SEATTLE, WA, 98111-1247, US

(73) Assignee: Monolithic Power Systems, Inc., Los Gatos, CA (US)

(21) Appl. No.: 11/444,784

(22) Filed: May 31, 2006

(51) Int. Cl. H05B 41/36

(52) U.S. Cl. 315/291

(57) ABSTRACT

A method for responding to an open lamp condition in a discharge lamp system is disclosed. The method monitors a current feedback signal flowing through a lamp and a voltage feedback signal indicative of a voltage across said lamp. A switch is used to switch between the current feedback signal to the voltage feedback signal upon detection of an open lamp condition.

### TECHNICAL FIELD

The present invention relates to the driving of fluorescent lamps, and more particularly, to methods and protection schemes for driving cold cathode fluorescent lamps (CCFL), external electrode fluorescent lamps (EEFL), and flat fluorescent lamps (FFL).

### BACKGROUND OF INVENTION

Fluorescent lamps are used in a wide variety of backlighting applications, such as for LCD displays, LCD televisions, and other types of consumer electronics. The fluorescent lamps are driven by an AC voltage. In mobile applications with typically only a DC power source, a DC/AC inverter is used to drive the fluorescent lamps. Even where AC power is available, a driver circuit is necessary to ensure that the appropriate AC driving waveform and voltage is applied to the lamps. The term controller encompasses both inverter and driver as used herein.

Typically, the backlight module includes more than one fluorescent lamp. When one or more of the fluorescent lamps fails, the failed fluorescent lamp presents an open circuit to the inverter or driver. This is referred to as an open lamp condition that causes the inverter to have an open lamp voltage.

Open lamp voltage handling and protection is often required in cold cathode fluorescent lamp (CCFL) inverter applications for safety and reliability reasons. In an open lamp condition, there might be a very large undesirable voltage occurring across outputs if protections are not in place. This undesirable voltage may be several times higher than a nominal output and could be harmful to circuit components. Thus, it is important for the inverter to safely and reliably operate under any anomalous conditions, such as an open lamp condition.

Under an open lamp condition, the lamp voltage will typically sweep up to 2˜2.5 times normal operating voltage. The controller will then try to strike the lamp for 1˜1.5 seconds. If the lamp does not turn on, the controller will shut down the system. Further, during the open lamp condition, the lamp voltage is much higher than the normal operating voltage. Therefore, the lamp voltage needs to be well controlled. If there are any instabilities in the system, the lamp and/or the controller can be easily damaged.

A prior art control scheme is shown in FIG. 1. The circuit includes a transformer with a primary side and a secondary side. The primary side is controlled by the (in this example) full bridge inverter. The full bridge inverter receives feedback from the secondary side of the transformer. Note that the lamp is connected to the secondary side of the transformer and sense nodes for current and voltage are used to feedback to the inverter.

Gvd is the transfer function from the duty cycle on the secondary winding to the output voltage. Gid is the transfer function from the duty cycle on the secondary winding to the lamp current. Cv represents the voltage sensing gain. Ri represents the lamp current sensing gain. Gm is the trans-conductance of the error amplifier. Gvt is the transfer function from the lamp voltage to time, during which the 140 uA current source discharges the compensation capacitor and lowers down the control voltage Vc. Fm represents the modulator gain.

Under normal operation, only the current loop operates. Under an open lamp condition, there are two cases. When all of the lamps are open, only the voltage loop works. When some lamps are open and some are still operating, both of the current loop and voltage loop work. Based on the system control chart in FIG. 1, the loop gain for both cases as shown in FIG. 2. FIG. 2(a) shows the loop gain under partial open lamp condition and FIG. 2(b) shows the loop gain under the complete open lamp condition.

The loop gain plots illustrate that the high Q of the resonant tank circuit of the inverter causes the system to be unstable because of little gain margin. It has also been found that a low frequency oscillation is observed. The frequency is determined by the difference between the resonant frequency and the switching frequency.

In order to achieve a stable system based on the prior art control method, either the loop gain must be lowered or the Q is dampened. If the gain is lowered, the lamp voltage regulation is lost. If the Q is dampened by inserting a resistor in the resonant tank, the system efficiency is adversely impacted.

### BRIEF DESCRIPTION OF DRAWINGS

The following figures illustrate embodiments of the invention. These figures and embodiments provide examples of the invention and they are non-limiting and non-exhaustive.

FIG. 1 shows a prior art open lamp protection circuit.

FIG. 2 shows the loop gain of the circuit of FIG. 1 when there is a partial open lamp condition (FIG. 2(a)) and when there is a complete open lamp condition (FIG. 2(b)).

FIG. 3 is a schematic diagram of the circuit of the present invention.

FIG. 4 shows the loop gain of the circuit of FIG. 3 when there is an open lamp condition.

FIG. 5 shows one implementation of the circuit of FIG. 3 for an in-phase fluorescent lamp application.

FIG. 6 shows one implementation of the circuit of FIG. 3 for an out-of-phase fluorescent lamp application.

### DETAILED DESCRIPTION

Embodiments of a system and method that uses logic and discrete components to achieve open lamp voltage protection are described in detail herein. In the following description, some specific details, such as example circuits and example values for these circuit components, are included to provide a thorough understanding of embodiments of the invention. One skilled in relevant art will recognize, however, that the invention can be practiced without one or more specific details, or with other methods, components, materials, etc.

The following embodiments and aspects are illustrated in conjunction with systems, circuits, and methods that are meant to be exemplary and illustrative. In various embodiments, the above problem has been reduced or eliminated, while other embodiments are directed to other improvements.

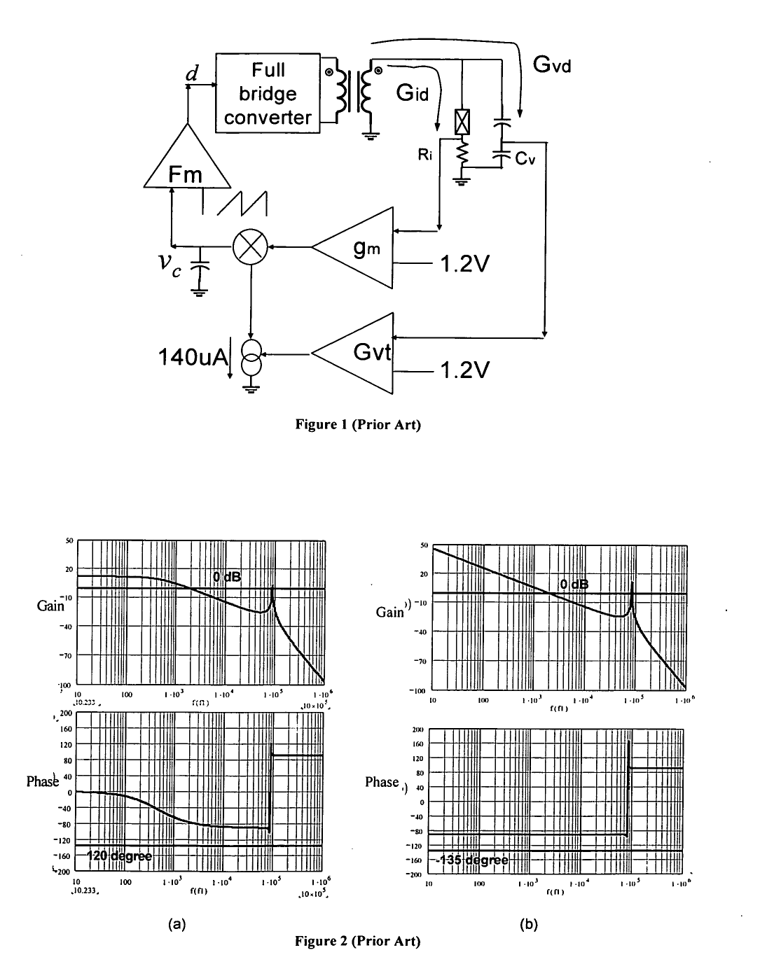

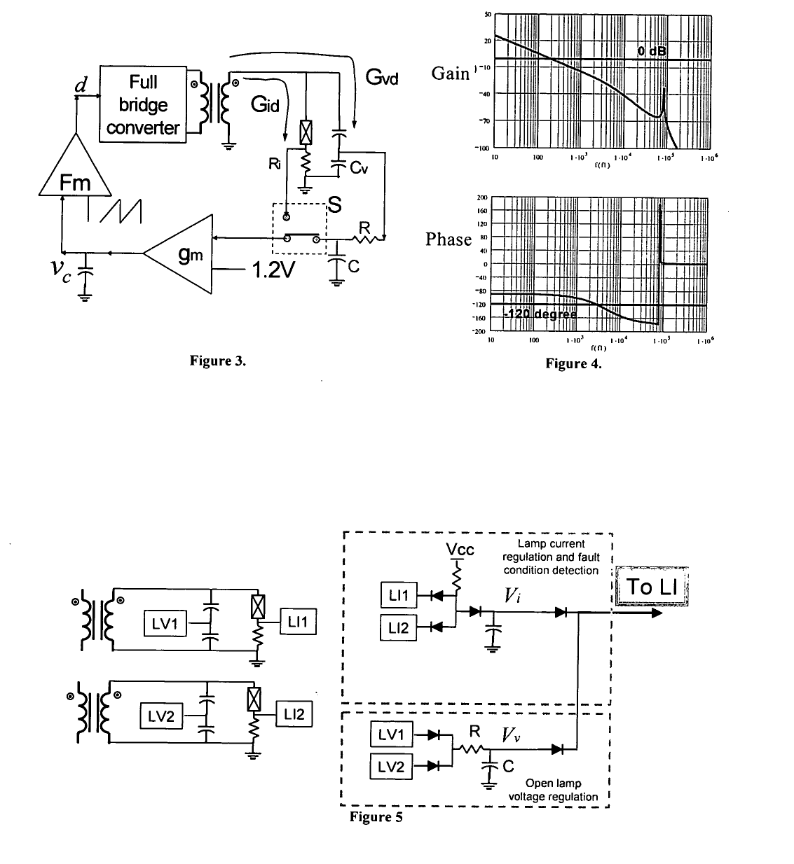

The present invention relates to circuits and methods of open lamp voltage protection in discharge lamp applications. FIG. 3 shows a circuit formed in accordance with the present invention. It is similar to the prior art of FIG. 1, though there are still significant differences. First, there is a switch to either route the lamp current or the lamp voltage as the feedback parameter. During the normal operation, the current loop is used as the feedback. Thus, the circuit behaves like the prior art circuit of FIG. 1.

Once the lamp is in an open lamp condition, the voltage loop kicks in and the current loop is disconnected. The switch thus moves to a position that allows the signal from the voltage loop to be fed back. Further, note that in the voltage loop, there is a low frequency filter (formed by R and C) to attenuate the high Q effect. The loop gain at open lamp condition is shown in FIG. 4. Another advantage of this control method is that only one error amplifier is needed.

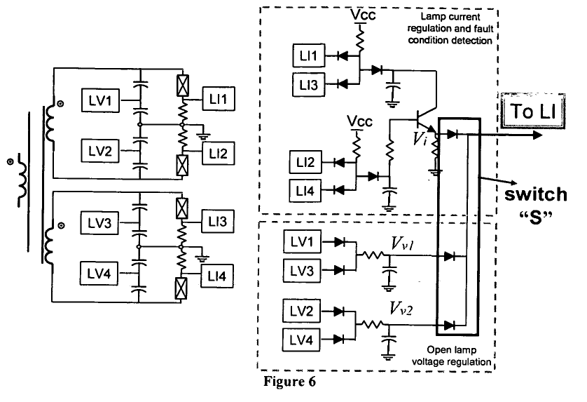

Moreover, the present invention can be applied to in-phase and out-of-phase applications, respectively. FIG. 5 shows the implementation for an in-phase CCFL. During normal operation, Vᵢ is greater than Vᵥ. Therefore, the lamp current is regulated. When the open lamp condition occurs, Vᵢ drops to zero. As a result, the lamp voltage, Vᵥ is regulated. It can be seen that the switch S is in this embodiment is comprised of two diodes. The low frequency filter is inserted into the voltage loop. Thus, the switch S can automatically detect an open lamp condition and switch in the voltage loop as the feedback.

FIG. 6 shows the implementation for an out-of-phase CCFL. During the normal operation, the lamp current is regulated. When the open lamp condition occurs, Vᵢ drops to zero. As a result, the lamp voltage, either Vᵥ₁ or Vᵥ₂ is regulated. The switch S is implemented in this embodiment by three diodes. The low frequency filter is inserted into the voltage loop to achieve a stable open lamp voltage.

The description of the invention and its applications as set forth herein is illustrative open lamp voltage protection and short circuit protection and is not intended to limit the scope of the invention. Variations and modifications of the embodiments disclosed herein are possible, and practical alternatives to and equivalents of the various elements of the embodiments are known to those of ordinary skill in the art. Other variations and modifications of the embodiments disclosed herein may be made without departing from the scope and spirit of the invention.

We claim:

1. A method for responding to an open lamp condition in a discharge lamp system, comprising:
monitoring a current feedback signal flowing through a lamp;
monitoring a voltage feedback signal indicative of a voltage across said lamp;
switching from said current feedback signal to said voltage feedback signal upon detection of said open lamp condition.

2. The method in claim 1, further comprising:
low pass filtering said voltage feedback signal.

3. The method in claim 1, wherein said voltage feedback signal and said current feedback signal are selectively switched to a single transconductance amplifier.

4. The method in claim 3, wherein said switch is formed from three diodes.

5. The method of claim 2 wherein said low pass filtering is performed with a RC filter.

6. An apparatus for handling an open lamp condition in a discharge lamp system comprising:
a current sensing means for sensing a current feedback signal through said discharge lamp system;
a voltage sensing means for sensing a voltage feedback signal indicative of the voltage across said discharge lamp system;
a switch that will selectively route said current feedback signal during normal operation and said voltage feedback signal under an open lamp condition;
a transconductance amplifier for receiving either said voltage feedback signal or current feedback signal through said switch; and
a feedback amplifier for receiving the output of said transconductance amplifier to control an inverter.

7. The apparatus of claim 6 wherein said switch is comprised of three diodes.

8. The apparatus of claim 6 furthering including a RC low pass filter for filtering said voltage feedback signal.
